(19) United States
(12) Patent Application Publication
(10) Pub. No.: US 2014/0030576 A1
(43) Pub. Date: Jan. 30, 2014

(54) HOUSING FOR ACCOMMODATING A FLAT ELECTROCHEMICAL CELL

(71) Applicants: Tim Schaefer, Harztor (DE); Christian Zahn, Dresden (DE); Felix Dunkel, Hoyerswerda (DE)

(72) Inventors: Tim Schaefer, Harztor (DE); Christian Zahn, Dresden (DE); Felix Dunkel, Hoyerswerda (DE)

(73) Assignee: Li-Tec Battery GmbH, Kamenz (DE)

(21) Appl. No.: 13/985,441

(22) PCT Filed: Feb. 2, 2012
(86) PCT No.: PCT/EP12/00478

§ 371 Date: Oct. 4, 2013

(30) Foreign Application Priority Data
Feb. 15, 2011 (DE) 10 2011 011 238.3

(51) Int. Cl. H01M 2/02

(52) U.S. Cl. CPC H01M 2/0207; H01M 2/024
USPC 429/120

(57) ABSTRACT

The invention relates to a housing (1) for receiving at least one flat electrochemical cell (2), comprising two housing side walls (4) which are disposed substantially parallel to one another, wherein a flat cooling bracket (9) is disposed on at least one flat electrochemical cell (2). The flat cooling bracket (9) is preferably disposed substantially parallel to the flat electrochemical cell (2). The flat electrochemical cell (2) may also have a sealing seam (3) extending at least in some regions on the edge of said cell and, for each flat electrochemical cell (2) to be received, the housing side walls (4) disposed parallel to one another comprise, in the inner faces thereof that are facing one another, a pair of opposite notches (5) configured to receive the at least one sealing seam (3) of the respective flat electrochemical cell (2).

The entire content of the priority application DE 10 2011 011 238.3 hereby is incorporated by reference into the present application.

The invention relates to a housing for accommodating at least one flat electrochemical cell with a sealing seam running at the edge thereof at least in certain areas, an arrangement of a plurality of such cells in such a housing and a method for producing such a housing or such an arrangement.

Electrochemical energy stores, also termed electrochemical or galvanic cells in the following, are often produced in the form of flat stackable units, from which, by means of the combination of a plurality of such cells, so-called batteries for various applications can be produced. For mechanically fixing the cells within such a stack arrangement of cells, arrangements of such cells have for example been suggested in DE 10 2009 005 124 A1, in which the cells are held in frames which are provided with suitable structural elements in order to thus combine the cells to form mechanically stable assemblies made up of a plurality of cells. With respect to vibration and impact protection of these cells in an energy store, a housing and an insulating wall region have been suggested in EP 2 249 414 A1, which have projections for accommodating the cells, wherein waste heat that arises is conveyed away via apertures. To prevent vibrations and resonance, it is suggested in WO 2006/059421 A1 to provide damping plates above and below the cell modules.

The present invention is based on the object of specifying a technical teaching for mechanically fixing or housing flat electrochemical cells, which avoids or overcomes the disadvantages and limitations of known solutions as far as possible.

This object is achieved by means of a housing for accommodating at least one flat electrochemical cell according to claim 1, by means of an arrangement of a plurality of such cells according to claim 19 and by means of a method for producing such a housing or such an arrangement according to claim 23. The subclaims relate to advantageous developments of the invention.

According to the invention, the housing for accommodating at least one flat electrochemical cell has two housing side walls arranged essentially parallel to one another, which are configured for accommodating the respective cell, wherein a flat cooling clip is arranged on at least one cell.

In the sense of the present invention, a housing is understood to mean any device which is suitable for shielding an electrochemical cell or an assembly made up of a plurality of electrochemical cells from undesired or disruptive influences from outside and/or protecting the surroundings of the electrochemical cell or the assembly of such electrochemical cells from undesired influences which may arise due to the operation of such cells. Preferably, in this case, such a housing prevents or impedes an undesired material transport or material exchange or energy exchange between the interior of the housing and the surroundings.

In this context, an electrochemical cell should be understood to mean an electrochemical energy storage, that is to say a device which can store energy in chemical form, output the same in electrical form to a consumer and preferably can also receive the same in electrical form from a charging device. Important examples for such electrochemical energy storages are galvanic cells or fuel cells.

In this context, a flat electrochemical cell should be understood to mean an electrochemical cell, the outer shape of which is characterised by two essentially parallel surfaces, the perpendicular spacing of which from one another is shorter than the average length of the cell measured parallel to these surfaces. The electrochemically active constituents of the cell are arranged between these surfaces, often enveloped by a packaging or a cell housing. Such cells are often surrounded by a multiple-layered film packaging which has a sealing seam at the edges of the cell packaging and is formed by a permanent connection or closing of the film packaging in the region of the sealing seam. Cells of this type are often also termed pouch cells or coffee bag cells.

In this context, a flat cooling clip should be understood to mean a bow-shaped component, like e.g. in the case of a bow or Lyra current collector, which is configured and arranged for supporting heat dissipation.

According to a preferred exemplary embodiment, the flat cooling clip is arranged essentially parallel to the cell, as a result of which the stability and the heat transfer can be increased.

Furthermore, the flat cooling clip can be formed from a heat-conducting material, as a result of which the heat dissipation can be increased. In addition, the flat cooling clip can be constructed elastically, as a result of which a damping can be achieved by means of deformations. Particularly preferably, the flat cooling clip is constructed in an essentially U-shaped manner with two indentations in the longitudinal direction. Furthermore, a flat cooling clip can be assigned to each cell in the housing.

Particularly preferably, the flat cooling clip has at least one coolant transfer part, which is configured for transferring a coolant, and a holding part, which is configured to butt against the flat cell. In particular, the flat cooling clip can have two coolant transfer parts which are each constructed as a stand part for the cooling clip. In addition, the holding part of the flat cooling clip can also be configured for transferring the coolant. Furthermore, the coolant clips can be configured for mutual connection.

Preferably, the cells have a sealing seam running at the edge thereof at least in certain areas, wherein the housing side walls have a pair of opposite notches for each cell to be accommodated in their inner surfaces, which are configured for accommodating the at least one sealing seam of the respective cell.

The configuration of the pair of opposite notches provided for accommodating the at least one sealing seam of the respective cell relates to the shape, size and arrangement of these notches, which are suitable for this purpose.

According to a preferred embodiment of the invention, a housing is provided, in which at least one housing wall arranged between the two housing side walls is provided, which has a notch in its inner surface for each cell to be accommodated, which is constructed for accommodating at least one sealing seam of the at least one cell. A housing wall of this type arranged between the two housing side walls preferably forms the base of the housing and/or the cover of the housing. In other embodiments of the invention, a further housing wall arranged between the two housing side walls can also be a housing partition wall which separates a plurality of layers of electrochemical cells, which are accommodated in a housing, from one another.

A further preferred embodiment of the invention provides at least one housing partition wall arranged between two notches, which is preferably arranged between two adjacent electrochemical cells. Housing partition walls of this type are preferably used to separate the adjacent electrochemical cells from one another thermally and/or mechanically, in order to avoid or prevent undesired interactions between adjacent electrochemical cells, as far as possible.

According to further preferred embodiments of the invention, at least one of the housing walls, housing partition walls or housing side walls is produced at least to some extent from a compressible, particularly preferably an elastic material. Particularly preferred here are materials made up of a foam, preferably of a polyethylene foam plastic. Such materials are particularly suitable for accommodating mechanical vibrations, impacts or other possibly damaging influences and for minimising or overcoming the effect thereof on the electrochemical cells arranged in the housing.

According to further preferred embodiments of the invention, provision is made for constructing the housing as a housing surrounding the entire cell body, preferably at battery module level, wherein vibration or thermal loads inevitable for the application are insulated or absorbed at least to some extent. Particularly preferably, provision is made for setting up the material of the housing block or the housing walls, housing partition walls or housing side walls with pockets in such a manner that even in the case of an ageing cell, a pressure optimal for cell operation can be maintained over the service life of the cell due to the partial elasticity of the material. In the case of so-called cell breathing of for example 3/10 or a thickness increase due to ageing, the optimum pressure can thus be maintained, as a result of which in particular the service life of cells, which contain separators made of Separion, the process of ageing and thus the service life of the cell can be positively influenced. This is preferably achieved by means of the flexible pressing of the cell walls onto the housing walls, housing partition walls or housing side walls provided with pockets in the process of ageing, with a simultaneously consequent lightweight construction.

According to a further preferred embodiment, the housing or the housing walls, housing partition walls or housing side walls are preferably outwardly protected from undesired influences by means of a multiple-layer composite material, by means of a hybrid material or by means of a fibre-composite material or by means of similar lightweight construction materials. Preferably, materials which conduct heat well are used in the process. By means of a suitable choice of the fibre composite materials used here, a high strength can be achieved and guaranteed, so that no particles or penetrating objects on or in the cell composite lead to short circuits or damage.

Preferably, an elastomer is used as a base or matrix material for this fibre-composite material. Preferably, the reinforcing fibres in this material are directed multidirectionally, preferably in a targeted fashion, or orientated unidirectionally. Due to a multidirectional orientation of the reinforcing fibres, an increase of the component strength of the walls of the housing is preferably achieved and the safety of the battery housing is therefore increased. Due to an e.g. unidirectional orientation of the reinforcing fibres in a targeted fashion at least in certain areas, the deformation of the housing walls, housing partition walls or housing side walls is preferably influenced. Preferably, a directed, locally different deformation of the housing walls, housing partition walls or housing side walls is thus achieved. Due to such a directed deformation of the housing walls, housing partition walls or housing side walls, it is in particular achieved that the same expands into cavities or recesses present, which surround the battery housing. Due to such a directed deformation, for example uncontrolled contact with objects which surround the battery housing, e.g. frame parts or further battery housing, is avoided and thus the safety of the battery housing is increased.

The reinforcing fibres of this fibre-composite material for this side wall according to the invention preferably consist of a plastic. Preferably, this has an expansion behaviour which deviates from the base material. Preferably, these reinforcing fibres consist of nylon or aramid. Preferably, the reinforcing fibres can also consist of a material from a different material group from plastic, thus e.g. these may be glass, metal, ceramic or carbon fibres. Preferably, the reinforcing fibres have a thickness from 1 μm to 1000 μm, preferably from 10 μm to 100 μm and particularly preferably from 20 μm to 40 μm. The expansion behaviour of these reinforcing fibres can preferably be influenced by their geometry, e.g. by the cross-sectional area lying normal to the main stress axis, or preferably by their modulus of elasticity. Due to the different expansion behaviour of the reinforcing fibres and the base material, the deformation behaviour of this side wall can be influenced and thus the safety of the battery housing can be increased.

Preferably, the side wall consists at least to some extent of a plastic with an elongation at break of 100% to 1000%, such as e.g. polyolefin, of a plastic with an elongation at break of 50% to 500%, such as e.g. polyamide or of a plastic with an elongation at break of 5% to 80%, such as e.g. polycarbonate. Preferably, the side wall consists at least to some extent of a plastic from the group of the polyethylene propylene dienes (EPDM). Preferably, this plastic is not only chemically attacked by the contents of an electrochemical energy storage device or by reaction products from the same or decomposed by the same. Preferably, it is prevented by means of a coating or by means of as protective device that reactive contents come into contact with this side wall.

Preferably, by means of a suitable choice of the plastic for the side wall, it is prevented that reactive substances escape from the battery housing and thus the safety is increased.

In the case of a fibre-composite material, the thermal conductivity is preferably achieved by means of a high proportion of thermally conductive fibres which preferably consist of a material with the previously mentioned thermal conductivity properties. Preferably, a fibre-composite material has a fibre content of 30 to 95% by volume, preferably of 40 to 80% by volume and particularly preferably with 50 to 65% by volume. Preferably, this is a material with a high thermal conductivity, preferably with a thermal conductivity at 20° C. of 40 to 1000 W/(K*m), preferably 100 to 400 W/(K*m) and particularly preferably approx. 220 W/(K*m). Preferably, this material has aluminium as an important constituent, further constituents may preferably be manganese, magnesium, copper, silicon, nickel, zinc and beryllium.

In the sense of the invention, a hybrid material is to be understood to mean a material which consists in certain areas of a plastic, preferably of a fibre-reinforced plastic, and preferably at least in certain areas of a metallic material. In those areas in which the hybrid material consists of a metal, it preferably has good thermal conductivity properties, in those areas in which this material consists of fibre-reinforced plastic, it preferably has good heat insulating properties. Preferably, this thermal conductivity is smaller than 0.5 W/(K*m), preferably smaller than 0.2 W/(K*m) and particularly preferably smaller than 0.1 W/(K*m) at 20° C. in each case. Due to the beneficial thermal conductivity properties and in the case of a hybrid material, also the good insulating properties of the battery housing, the temperature balance of the energy storage devices can be influenced simply and thus the operational reliability can be increased.

Preferably, the housing according to the invention or the arrangement according to the invention has a cell pressure distribution layer. In particular, the cell pressure distribution layer is used for the two-dimensional distribution of a force or a pressure which is exerted by a foreign body onto this cell pressure distribution layer. In particular, the cell pressure distribution layer separates the battery cell from a foreign body. Preferably, a cell pressure distribution layer has at least one material from the following group, which contains: iron-containing alloys, steel, lightweight metals such as aluminium, titanium or magnesium, particularly cross-linked plastics, plastics with fillers and/or woven/non-woven fabrics, particularly with carbon, glass and/or aramid fibres.

Preferably, a cell pressure distribution layer has honeycomb structures, particularly with aramid fibres and/or a metal film, wherein particularly preferably, the longitudinal axes of the honeycombs are arranged in the direction of the foreign body which is acting. Preferably, the honeycombs are closed in the longitudinal direction with a cover layer. Preferably, the cell pressure distribution layer has a rib or web which particularly preferably extends in the direction of an expected foreign body. The cell pressure distribution layer is preferably only arranged in certain regions of the housing or the arrangement, particularly preferably in regions in which an endangerment is to be expected due to a foreign body with a particularly small end face. Preferably, a cell pressure distribution layer is constructed in an electrically conductive manner at least in certain areas, particularly by means of a metallic coating and/or a metal wire.

Preferably, at least in certain areas, the housing has a material from the following group, which contains: iron-containing alloys, steel, lightweight metals such as aluminium, titanium or magnesium, plastics, such as in particular PP, PA or PE, which are cross-linked in particular and which are in particular stiffened with fillers and/or woven/non-woven fabrics, particularly with glass and/or aramid fibres. Preferably, the housing has a honeycomb structure at least in certain areas, particularly preferably with aramid fibres and/or with a metal film, wherein particularly preferably, the longitudinal axes of the honeycombs are arranged in the direction of the foreign body which is acting.

According to further preferred embodiments of the invention, provision is made for providing the material of the housing walls, housing partition walls or housing side walls with fire-retardant additives or with extinguishing agents or with extinguishing-agent additives, in order in the event of a fire of a cell, to be able to achieve an extinguishing action as close as possible to the source of the fire and preferably also without influence from outside.

In this context, a fire is to be understood to mean any process in which the energy storage or parts of the energy storage or the surroundings thereof are converted or decomposed in an undesired chemical reaction. In this sense, fires are in particular exothermic chemical reactions of elements or components of an energy storage or the surroundings thereof, which frequently occur as a consequence of overheating of the energy storage or the components thereof.

In this context, an extinguishing agent should be understood to mean a substance or a substance mixture which exerts an extinguishing action, that is to say preferably an inhibitory action on fires and/or prevents or impedes the development of fires. In connection with the present invention, an extinguishing action should preferably be understood to mean an action which counteracts a fire, i.e. which can prevent or mitigate the consequences or the development of a fire. Important examples for extinguishing agents or their preferred contents are substances which withdraw a chemical reaction partner from a source of a fire, without which the fire cannot be maintained, or which inhibit a chemical reaction which is beneficial for the initiation or maintenance of a fire. Extinguishing agents are preferably produced by mixing an extinguishing-agent additive or a fire-retardant additive with a solvent or with a carrier.

In connection with the present invention, preferably so-called D extinguishing powder (also: metal fire powder, metal fire extinguishing powder, M powder) or a so-called ABC extinguishing powder, i.e. preferably an extinguishing-agent additive or fire-retardant additive which overwhelmingly consists of the finest milled ammonium phosphate and ammonium sulphate, are considered as fire-retardant additives. In this context, preferred D extinguishing powders preferably mainly consist of the finest milled alkali chlorides (often sodium chloride). A particular feature of these substances is their high reaction and temperature stability.

In connection with this invention, preferred extinguishing-agent additives or fire-retardant additives are so-called gelling agents, which, in connection with other materials, solvents or carriers, such as preferably water, form preferably adhesive and preferably viscous gels or viscoelastic fluids which preferably stand out due to their high adhesion on burning objects and their surfaces. Gelling agents are preferred examples for extinguishing-agent additives which are preferably based on so-called superabsorbers and which preferably are stored as powder or solid materials or else as emulsions. Superabsorbers can often accommodate a multiple of their weight or volume in water or a different carrier substance. Water-based gels, which are formed by corresponding superabsorbers by mixing with water, have the advantage compared to conventional foam carpets, that an airtight barrier layer is formed, which remains intact longer than in the case of conventional foam carpets and which outputs considerably less water to the burning material.

In connection with the present invention, a viscoelastic fluid should be understood to mean a fluid which has the property of viscoelasticity. An (ideal) fluid is understood to mean a substance which sets (approximately) no resistance against an arbitrarily slow shear. One differentiates compressible fluids (gases) and incompressible fluids (liquids). The superordinate term “fluid” is used, because most physical laws apply equally for gases and liquids (approximately) and many of their properties only differ from one another quantitatively, but not fundamentally qualitatively. Real fluids can be divided on the basis of their behaviour into “Newtonian fluids” with the flow mechanics which define them and Non-Newtonian fluids with the rheology defining them. The difference here consists in the flow behaviour of the medium, which is described by the functional connection of thrust stress or shear stress and distortion rate or shear speed.

One defines viscoelasticity as the time-, temperature-and/or frequency-dependent elasticity of fluids, such as e.g. of polymer melts or solid bodies, such as for example plastics. The viscoelasticity is defined by a partly elastic, partly viscous behaviour. Following the removal of a force acting from outside, the material returns to its initial state only unsatisfactorily; the remaining energy is removed in the form of flow processes.

In connection with the description of the present invention, a gel should be understood to mean a finely dispersed system made up of at least one first, often solid, and at least one second, often liquid, phase. A gel often constitutes a colloid. The solid phase in this case forms a sponge-like, three-dimensional network, the pores of which are filled by means of a liquid or else by means of a gas. Both phases are in this case often penetrated completely. Colloids are defined as particles or droplets which are finely dispersed in another medium (solid, gas or liquid), the dispersion medium.

According to a further preferred embodiment of the invention, an electrochemical energy store is provided, in which the extinguishing agent or the extinguishing-agent additive is a solid or an elastically deformable material or is contained in such a material. The term solid should in this context also comprise pressed aggregations of powders or foams, preferably elastically deformable foams.

According to a further preferred embodiment of the invention, an electrochemical energy storage is provided, in which the extinguishing agent or the extinguishing-agent additive is arranged as spacers or edge protection plates between each two adjacent electrochemical cells or between one electrochemical cell and a housing wall.

According to a further preferred embodiment of the invention, an electrochemical energy storage is provided, in which the extinguishing agent or the extinguishing-agent additive can accommodate or contains a multiple of its volume in water. Extinguishing agents based on gelling agents, preferably those which contain extinguishing-agent additives based on so-called superabsorbers are particularly preferred in this context.

According to a further preferred embodiment of the invention, an electrochemical energy storage is provided, in which the extinguishing agent or the extinguishing-agent additive contains at least one polymer, preferably a copolymer, particularly preferably an acrylamide copolymer or a sodium acrylate copolymer.

According to a further preferred embodiment of the invention, an electrochemical energy storage is provided, in which the extinguishing agent or the extinguishing-agent additive contains at least one fatty acid ester.

According to a further preferred embodiment of the invention, an electrochemical energy storage is provided, in which the extinguishing agent or the extinguishing-agent additive contains at least one tenside.

According to a further preferred embodiment of the invention, an electrochemical energy storage is provided, in which the extinguishing agent or the extinguishing-agent additive contains at least a mixture or an emulsion made up of water and at least one fatty acid ester, at least one polymer, preferably a copolymer, particularly preferably an acrylamide copolymer or a sodium acrylate copolymer.

According to a further preferred embodiment of the invention, an electrochemical energy storage is provided, in which the extinguishing agent contains a mixture or an emulsion of approx. 28% of at least one polymer, approx. 6% of at least one tenside, approx. 23% of at least one ester oil and approx. 43% water.

According to a further preferred embodiment of the invention, an electrochemical energy storage is provided, in which the extinguishing agent is used in connection with water and contains a mixture or an emulsion of approx. 50% of at least one polymer, approx. 10% of at least one tenside and approx. 40% of at least one ester oil.

According to a further preferred embodiment, the carrier substance, with which the extinguishing-agent additive can mix to form an extinguishing agent, is a coolant which flows through a coolant circuit, which is closed during the normal operation of the energy store and is configured in such a manner that in the event of a fire, the coolant can escape from the closed coolant circuit at certain locations and an extinguishing action can unfold at these locations. In this manner, the extinguishing action can be unfolded in a targeted fashion at certain locations which are affected by a fire; at the same time, the action as a coolant can be retained.

In the sense of the present invention, a coolant should be understood to mean a flowable material, preferably a gaseous or liquid heat transport medium, which receives heat from its surroundings, transports this heat by flowing, and can also discharge this heat to its surroundings, and which owing to its physical properties, is suitable for transporting heat by heat conduction and/or heat transport via aerodynamic or hydrodynamic flows, particularly also via convection flows, in the heat transport medium. Important examples for heat transport media generally used in the art are for example air or water or other common coolants. Depending on the application context, other gases or liquids are also common, for example chemically inert (less reactive) gases or liquids, such as for example noble gases or liquefied noble gases or substances with a high heat capacity and/or thermal conductivity.

In this context, a flowable material should be understood to mean any material in which a flow can form in the aero- or hydrodynamic sense, or in which such a flow can be maintained. Examples for such materials are gases and liquids in particular. Flows in this sense can however also be maintained or develop in a mixture of liquids or gases and finely-distributed solid bodies, so-called aerosols, or in colloidal solutions.

A particularly preferred apparatus according to the invention has a device for stabilising the coolant pressure in the case of a localised escape of the coolant from the coolant circuit in the event of a fire. This embodiment of the invention may be connected with a substantial or complete retention of the coolant pressure and thus the cooling action if the coolant escapes from the coolant circuit in a localised manner, in order to unfold its extinguishing action at these locations.

The localised escape of the coolant in the event of a fire is preferably effected in this case by means of valves with a preferably mechatronic or sensory trigger mechanism. Thus, it is possible to apply an extinguishing agent in a targeted fashion onto a continuous cell in the event of a fire and to prevent the so-called cascade effect.

Also preferred is an embodiment of the invention, in which water is used as coolant and in which this coolant flows through a coolant circuit, which is closed during normal operation of the energy storage and is configured in such a manner that the water can escape from the closed coolant circuit at certain locations in the event of a fire and is mixed with an extinguishing-agent additive when escaping from the coolant circuit, wherein a gel or a viscoelastic fluid is formed.

Particularly preferred in this case is the use of an extinguishing-agent additive consisting of a mixture of at least one polymer, at least one tenside and at least one ester oil.

Further particularly preferred is an additive consisting of a mixture of approx. 50% of a polymer, approx. 10% of at least one tenside and approx. 40% of at least one ester oil.

When measuring the mixing ratios, it is preferably to be taken into account that the advantageous effects of the cooling and extinguishing mixture or the additive are based on the viscoelasticity of the cooling and extinguishing mixture and on the capacity thereof to bind water. As a result, the adhesion force of the coolant can also be increased on smooth surfaces. The liquid does not run off unused.

Particularly in the case of mixtures of polymers, ester oils, tensides and water, a suitable measuring of the mixing ratios under the influence of kinetic energy leads to a substantial reduction of the viscosity compared to the rest state. As a result, a mixture of this type with low viscosity can flow through a coolant circuit and at the same time have a high viscosity when its escapes from this coolant circuit at the location of a fire. The flowability of such mixtures is therefore mainly dependent on the flow speed.

Due to the chemical/physical binding of the liquid into a gel structure, the vaporisation rate of the liquid can also be reduced considerably at higher temperatures. As a result, the liquid consumption can be reduced considerably. At the location of the fire, the liquid bound into a gel structure can develop an increased cooling action due to the relatively high layer thickness and the reduced vaporisation rate. This effect is of particular importance when fighting fires with very high temperatures.

In a few preferred embodiments, the extinguishing-agent additive preferably has the form of a mixture consisting of P % by weight of at least one polymer, T % by weight of at least one tenside and E % by weight of at least one ester oil, with respect to the overall quantity of the additive, wherein the following is true:

45≦P≦55,

8≦T≦12,

35≦E≦45

and

P+T+E=100

According to further preferred embodiments of the invention, provision is made for at least one heat-conducting or heat-transporting structure to be embedded in at least one of the housing walls, housing partition walls or housing side walls. In this case, it may preferably be an arrangement of cooling channels, heat conductors or heat pipes. In this manner, it is possible to stabilise the operating temperature of the electrochemical cells and to contribute in this manner to an operation of the electrochemical cells which is as efficient and safe as possible.

The heat-conducting or heat-transporting structures are preferably cooling channels, wires or similar structures with a comb shape or YO shape, which are preferably arranged axially and with legs spread apart. By means of these embodiments, it is possible to achieve it that the housing block or the entire arrangement is mechanically stabilised and held and the cooling approaches the cells on the material side and has the function of a supporting element which acts in a vibration-inhibiting manner. Preferred materials in this context are C fibres, copper, heat-conducting films or cooling ribs.

According to further preferred embodiments of the invention, provision is made for at least one of the housing walls, housing partition walls or housing side walls to have a preferably gas-filled cavity. Such cavities are preferably used to enable an expansion of the electrochemical cells during continuous operation and to accommodate the volume enlargement of the cells connected therewith, in order to avoid or alleviate disadvantageous effects of such volume increases of individual cells on adjacent cells.

According to the invention, an arrangement with a plurality of flat electrochemical cells with a sealing seam running at the edge of the cells at least in certain areas and with an above-described housing is further provided. Preferably, provision is made in this case for the sealing seams of the cells to be embedded into the notches in the housing walls and/or in the housing side walls at least in certain areas and at least to some extent.

According to further preferred embodiments of the arrangement according to the invention, provision is made for the cells to be held in the housing by means of a frictional connection between the cells and at least one of the housing walls, housing partition walls or housing side walls.

According to the invention, further provided is a method for producing a housing or an arrangement according to the invention, in which the housing is cut entirely or to some extent from a slab.

The features of the described and further embodiments of the invention can be combined with one another in an advantageous manner, as a result of which further embodiments of the invention are available to the person skilled in the art, which cannot be described in a finished and complete manner here.

In the following, the invention is explained in more detail on the basis of preferred embodiments and with the aid of figures. In the figures

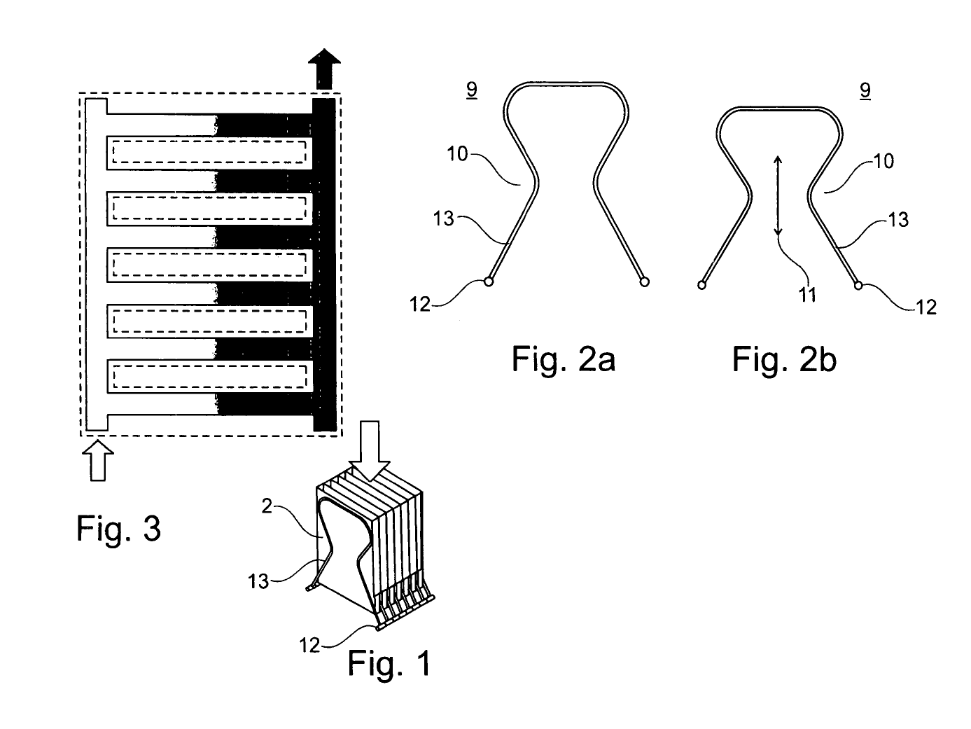

FIG. 1 shows an arrangement according to the invention of flat electrochemical cells with flat cooling clips in a schematic manner;

FIG. 2a shows a cooling clip in an unloaded state in a schematic manner;

FIG. 2b shows a cooling clip in a loaded state in a schematic manner;

FIG. 3 shows the heat flow in an arrangement of flat electrochemical cells with flat cooling clips according to FIG. 1 in a schematic manner;

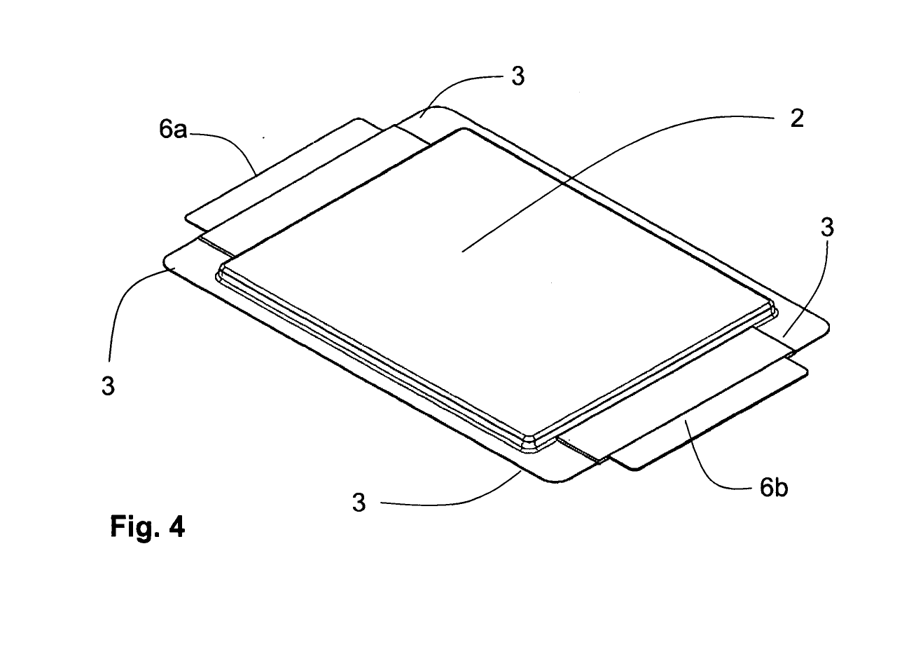

FIG. 4 shows a first embodiment of a flat electrochemical cell in a schematic manner;

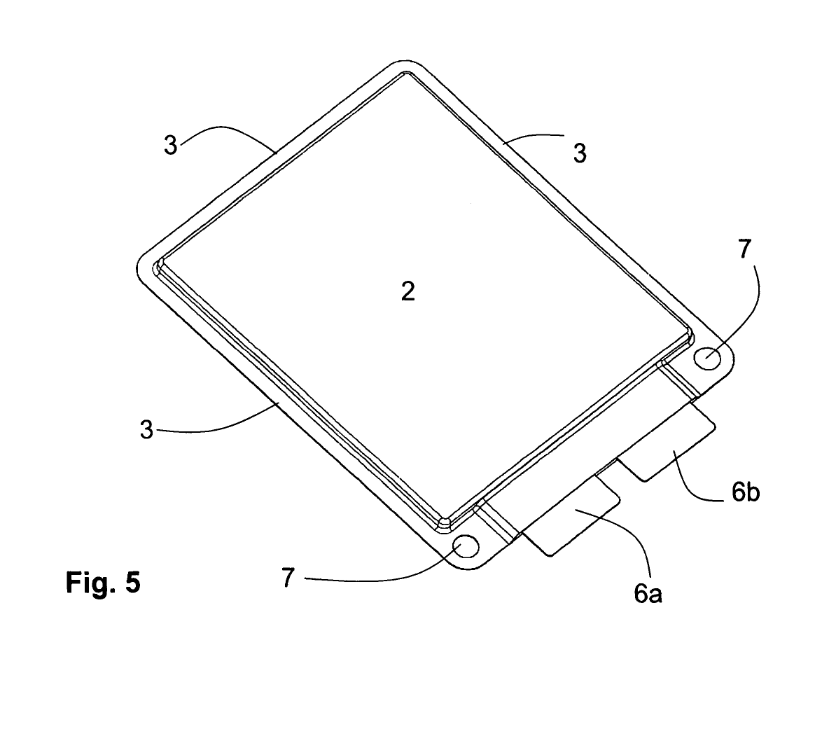

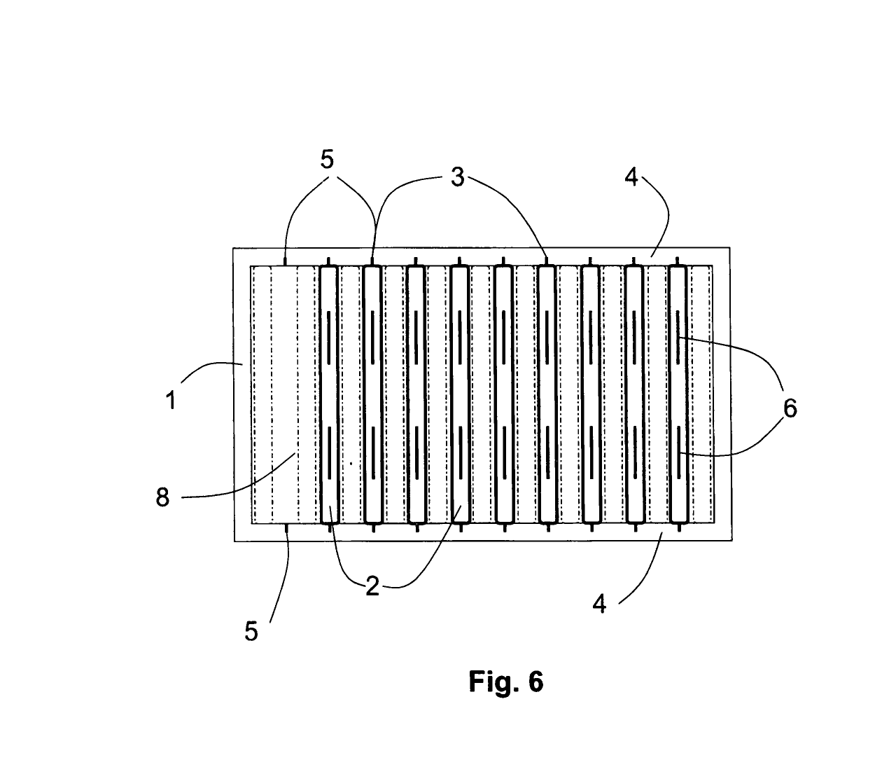

FIG. 5 shows a second embodiment of a flat electrochemical cell in a schematic manner;

FIG. 6 shows an arrangement according to the invention of a plurality of electrochemical cells according to a preferred embodiment of the invention in a schematic manner;

FIG. 7 shows a further preferred embodiment of an arrangement according to the invention in a schematic manner; and

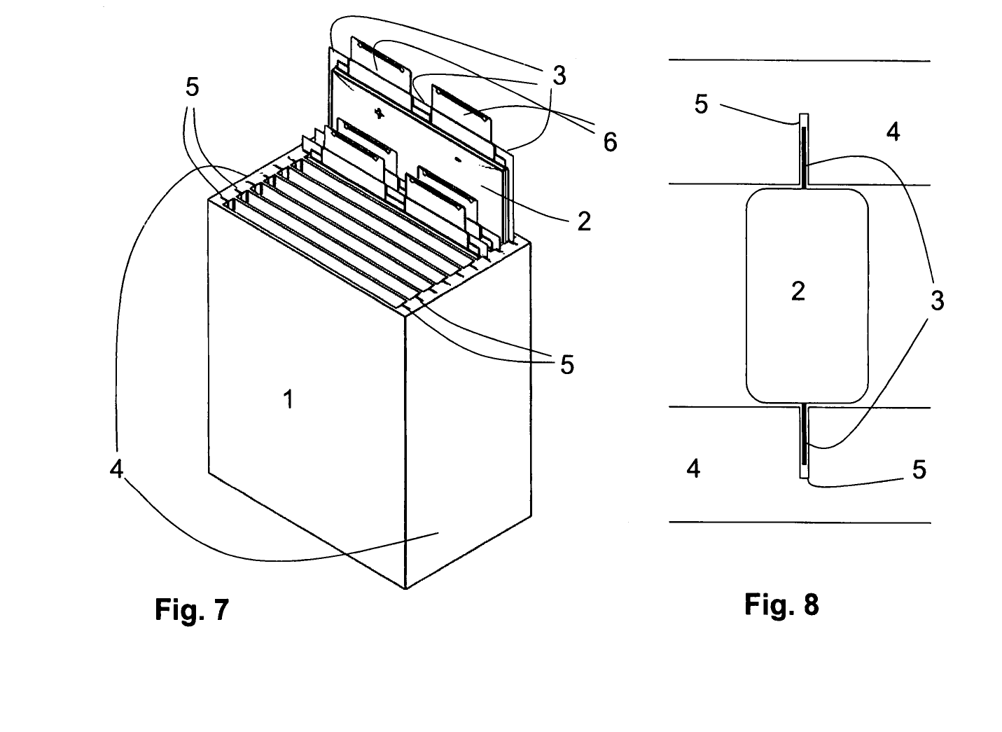

FIG. 8 shows a sectional image of a section of an arrangement according to the invention in a schematic manner.

FIG. 1 shows an arrangement according to the invention of flat electrochemical cells 2 with flat cooling clips 9 in a schematic manner. In this embodiment, the cooling clip 9 has a coolant transfer part 12, which is configured for transferring a coolant, and a holding part 13, which is configured for lying on the flat electrochemical cell 2. As is shown in FIG. 1, the coolant transfer part 12 can be constructed as a stand part for the cooling clip. Furthermore, the cooling clips 9 can be configured for mutual connection and for transferring the coolant.

It can be seen from FIGS. 2a and 2b that the cooling clip can be constructed in a U-shaped manner with two indentations 10 along the longitudinal direction 11 of the cooling clip 9, wherein the FIG. 2a shows the cooling clip 9 in an unloaded state and FIG. 2b shows the cooling clip 9 in a loaded state. Due to an elastic configuration of the cooling clip 9, a damping due to deformation can be achieved with the two indentations 10, particularly against loads which occur from the loading direction indicated with the arrow 14, and the stability of the arrangement can therefore be increased. FIG. 3 shows the heat flow of the arrangement shown in FIG. 1 of electrochemical flat cells 2 with cooling clips 9, which are connected to one another for the continuous transfer of the coolant, in a schematic manner in plan view.

FIG. 4 shows an embodiment of a flat electrochemical cell 2 in a schematic manner, in which the conductors 6a and 6b, that is to say the electrical terminals of the cells are guided at opposite ends of the cell out of the envelope or packaging of the cell. The packaging or envelope of the electrochemical cell is closed at the side with the aid of a sealing seam 3, which is formed for example by means of a hot sealing step or similar process steps, in which for example the plurality of layers of the packaging film are connected to one another in a materially connected manner, so that an exchange of material between the interior of the electrochemical cell and the surroundings thereof is practically ruled out.

As illustrated in FIG. 4, the sealing seam 3 is regularly considerably thinner than the actual body of the electrochemical cell. As a result, the sealing seam is suitable to be embedded into a notch in a housing wall of a housing according to the invention for accommodating one or a plurality of electrochemical cells of this type.

FIG. 5 shows a further preferred embodiment of a flat electrochemical cell in a schematic manner, in which the conductors 6a and 6b are guided at the same end out of the edge of the envelope or packaging of the electrochemical cell. As in this exemplary embodiment of the flat electrochemical cell 2, no conductors are guided out of the edge region of the cell at the opposite end, the width of the sealing seam 3 is narrower at this opposite end than at the end, out of which the conductors 6a and 6b are guided. Therefore, not only the side regions of the sealing seam 3, but also the region of the sealing seam 3 opposite the conductors are suitable to be embedded into a notch in a wall of a housing according to the invention. In the embodiment shown in FIG. 5, circular openings 7 through the sealing seam, which can be used for fixing the cell, are provided at the end of the cell in which the conductors are guided out of the edge region and at which the sealing seam is correspondingly wider.

The embodiment of the electrochemical cell shown in FIG. 4 is therefore especially suitable for housing shapes in which 2 opposite housing side walls of the housing according to the invention have notches, in which the sealing seam 3 can be embedded, whereas the embodiment of an electrochemical cell shown in FIG. 5 is suitable in a particular manner for being embedded by means of its sealing seam 3, not only into notches in the two side walls, but also into a notch in the base plate of a housing.

FIG. 6 shows an exemplary embodiment of a housing according to the invention in a schematic manner, with two opposite housing side walls 4, which have notches 5, into which the sealing seams 3 of a plurality of electrochemical cells 2 with conductors 6 are embedded. Housing partition walls 8 are arranged between the electrochemical cells.

FIG. 7 shows a perspective side view of a preferred embodiment of a housing 1 according to the invention in a schematic manner, in which the electrochemical cells of the design shown in FIG. 5, in which the conductors protrude out of the wall region at the same end of the galvanic cell and are embedded by means of their sealing seams 3 into the notches 5 of the housing side walls 4 of the housing 1.

FIG. 8 shows an enlarged illustration of a section of an arrangement according to the invention in a schematic manner, in which an electrochemical cell 2 is embedded by means of its sealing seams 3 into notches 5 of two opposite housing side walls 4 of a housing 1.

The illustrations in the figures are preferably schematic and in particular often not necessarily true to scale.

The present invention and its embodiments offer the advantageous option of dispensing with a frame structure for the electromagnetic cells and instead to insert the cells into a housing according to the invention via cooling clips and/or by means of the sealing seam thereof. It is also advantageous in particular that in addition to accommodating the cells, a desired heat dissipation can also be achieved via the cooling clips.

A further advantage lies in preserving the sealing seam of the electrochemical cells in the case of a corresponding choice of the housing material, which preferably consists of a compressible and elastic material, particularly preferably of a foam plastic material. This is achieved in particular in that in some embodiments of the invention, the cell can be held by means of a frictional connection over the entire surface and as a result is additionally relieved. Particularly those embodiments of the invention which have recourse to corresponding materials and/or to the possibility of using housing partition walls offer additional protection from mechanical influences on the cells, for example from the effects of undesired vibrations.

When using a compressible material for the housing or housing walls, particularly housing side walls, housing base plates or housing partition walls, preferably a foam plastic, the advantageous possibility results, that the electrochemical cells can expand their volume without there being a fear of undesired influences on adjacent cells or any other damage as a result. In addition, production tolerances during the production of electrochemical cells can be well compensated by means of suitably realised embodiments of the invention. In the case of a corresponding material choice, considerable weight savings are possible compared to batteries in which the electrochemical cells are held by means of frame structures.

In the housing partition walls, in those embodiments which provide such partition walls, wire elements can for example be embedded into these housing partition walls. This is for example very advantageously possible if the housing partition walls consist of a foam plastic material. In addition to wire elements, other heat-conducting means or heat-transporting means can be embedded into the housing partition walls or else into other housing walls.

If the housing according to the invention or parts of this housing are produced from foam material, such foam blocks can be produced cost effectively as products sold by the metre or as a slab and cut to an appropriate size if required.

### REFERENCE LIST

1 Housing

2 Electrochemical cell

3 Sealing seam

4 Housing side wall

5 Notch

6a First conductor

6b Second conductor

7 Circular opening

8 Housing partition wall

9 Cooling clip

10 Indentation on the cooling clip

11 Longitudinal direction of the cooling clip

12 Coolant transfer part

13 Holding part

14 Loading direction

1-23. (canceled)

24. An arrangement of flat electrochemical cells and a housing that accommodates the plurality of flat electrochemical cells, wherein the housing includes two side walls arranged substantially parallel to one another and configured to accommodate the plurality of flat electrochemical cells, and a flat cooling clip is arranged on at least one of the plurality of flat electrochemical cells, the flat cooling clip being arranged substantially parallel to the at least one of the plurality of flat electrochemical cells, the flat cooling clip being formed in a U-shape and including two indentations in a longitudinal direction.

25. The arrangement according to claim 24, wherein the at least one of the plurality of flat electrochemical cells are held by the flat cooling clip.

26. The arrangement according to claim 24, wherein the flat cooling clip is formed from a heat-conducting material.

27. The arrangement according to claim 24, wherein the flat cooling clip has an elastic construction.

28. The arrangement according to claim 24, wherein the flat cooling clip includes at least one coolant transfer part configured to transfer a coolant, and includes a holding part configured to butt against the at least one of the plurality of flat electrochemical cells.

29. The arrangement according to claim 28, wherein the flat cooling clip includes two coolant transfer parts each formed as a stand for the cooling clip.

30. The arrangement according to claim 28, wherein the holding part of the flat cooling clip is configured to transfer the coolant.

31. The arrangement according to claim 24, wherein the flat cooling clip is configured to connect to another flat cooling clip.

32. The arrangement according to claim 24, wherein one flat cooling clip is arranged on each of the plurality of flat electrochemical cells.

33. The arrangement according to claim 24, wherein at least one of housing walls, housing partition walls or the housing side walls is formed of a compressible, elastic material.

34. The arrangement according to claim 24, wherein at least one of the at least one of housing walls, housing partition walls or the housing side walls is formed of a foam including polyethylene foam plastic.

35. The arrangement according to claim 34, wherein at least one heat-conducting or heat-transporting structure is embedded into at least one of the housing walls, housing partition walls or housing side walls.

36. The arrangement according to claim 33, wherein at least one of the housing walls, the housing partition walls or the housing side walls includes at least one gas-filled cavity.

37. The arrangement according to claim 33, wherein at least one of the housing walls, the housing partition walls, or the housing side walls includes at least one fire-retardant additive, extinguishing agent or extinguishing agent additive.

38. The arrangement according to claim 33, wherein the plurality of flat electrochemical cells are held in the housing by a frictional connection between each of the plurality of flat electrochemical cells and at least one of the housing walls, the housing partition walls or the housing side walls.
